(19) United States
(12) Patent Application Publication
(10) Pub. No.: US 2004/0095534 A1
(43) Pub. Date: May 20, 2004

(54) [STRUCTURE OF LIQUID CRYSTAL DISPLAY]

(76) Inventor: Yung-Hsun Wu, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,014

(22) Filed: Nov. 14, 2003

(30) Foreign Application Priority Data
Nov. 15, 2002 (TW) 91133475

(51) Int. Cl. G02F 1/1335

(52) U.S. Cl. 349/117

(57) ABSTRACT

A structure of a liquid crystal display, having a first polarizer with a polarization direction along a first angle, a first phase retardation plate disposed in front of the first polarizer to produce phase retardation effect along the first angle, a first wide view film disposed in front of the first phase retardation plate along a second angle perpendicular to the first angle. A liquid crystal display is disposed in front of the first viewing angle with the liquid crystal molecules thereof arranged along the second angle. The structure further has a second wide view film in front of the liquid crystal display along the first angle, and a second phase retardation plate in front of the second wide viewing angle along the second angle. A second polarizer is further disposed in front of the second phase retardation with a polarization direction along the second angle.

### CROSS REFERENCE TO RELATED APPLICATIONS

This application claims the priority benefit of Taiwan application serial no. 91133475, filed Nov. 15, 2002.

### BACKGROUND OF INVENTION

1. Field of the Invention

The invention relates in general to a liquid crystal display apparatus, and more particularly, to a structure of a liquid crystal display.

2. Related Art of the Invention

Displays are one of the most commonly seen appliances in our daily lives.

Particularly for television and computers, images are displayed on display screens for the user. The conventional cathode ray tube (CRT) display requires a sizable dimension and causes great inconvenience. Further, such displays cannot be applied to laptop computers. Therefore, dot-matrix flat panel displays such as liquid crystal display (LCD), including thin-film transistor (TFT) liquid crystal display have been developed.

For the thin-film transistor liquid crystal display, the visual effect of image and text is dependent on the viewing angle. With an excessively large viewing angle, the visual effect, such as the image light contrast, is reduced. Wide viewing (VW) angle technique has been a very important technique to achieving high image quality of thin-film transistor liquid crystal display. Among the various techniques, the application using a wide view film is the fastest way to achieve the wide viewing angle effect. FIG. 1A shows a schematic top view of the relationship between the viewing angle and the liquid crystal display. FIG. 1B shows the side view corresponding to the top view shown in FIG. 1A. As shown in FIGS. 1A and 1B, a wide view film 110 is formed to cover a liquid crystal display device 100. An image is viewed at four positions with the viewing angles 56, 54, 50 and 52. With the wide view film 110, when the left and right viewing angle is about 600, the contrast ratio (CR) is about 10, while the up and down viewing angles are about 300 and 600. This is still insufficient for a typical terminal display.

In the typical liquid crystal display, when liquid crystal material such as an intermediate between crystal and liquid is excited by an external force such as an electric field, the liquid crystal molecules thereof are rearranged. The arrangement of the molecules thus polarizes the light beams into various directions. According to this property, a display device is fabricated. Currently, the liquid crystal display has been broadly applied for having the advantages of being light, thin, and having low driving voltage, small volume and low power consumption. However, how to obtain a high quality image display is still an important goal of the liquid crystal display.

The operation theory of the liquid crystal display is shown as FIG. 2. FIG. 2 shows the display theory of the twisted nematic (TN) liquid crystal display. The liquid crystal layer 108 is filled between glasses 106. On each external side of the glasses 106, a polarizer 104 is disposed. The polarizers 104 on the opposing sides of the glasses 106 have polarization directions perpendicular to each other. In the left part of the FIG. 2, when a light beam is polarized by the upper polarizer 104 and enters the liquid crystal layer 108 without the application of any voltage, the polarization direction of the light beam rotated by 900 due to the twisted nematic from one polarizer 104 to the other polarizer 104 is 900. As the polarizations of the opposing polarizer 104 are perpendicular to each other, the light beam can pass through the lower polarizer 104.

If a voltage is applied to the liquid crystal layer 108 as shown in the right part of FIG. 2, the liquid crystal molecules are arranged along a straight line. Therefore, the polarization direction of the light beam traveling through the liquid crystal layer 108 will not be changed thereby, and therefore, cannot travel through the lower polarizer 104. Under such conditions, the light beam travels through the liquid crystal device when the voltage is not applied thereto, and is blocked when the voltage is applied thereto.

For the thin-film transistor liquid crystal, a semiconductor technique is used to fabricate a thin-film transistor array corresponding to each pixel. With the voltage generated by the thin-film transistor, the twisted nematic liquid crystal of each pixel is controlled to determined whether the light beam is traveling through or not. The liquid crystal may also color effect by voltage control. Such effect is not essential to the present invention and is not described in detail in the specification.

In the typical liquid crystal display, the pair of polarizers is inevitable. When the light beam travels through the polarizers, additional phase retardation is produced causing leakage of light and affecting the contrast ratio along the wide viewing angle direction, however the wide viewing angle is the crucial technique allowing the thin-film transistor liquid crystal to realize the high quality.

FIG. 3 shows a schematic drawing of the structure of a conventional liquid crystal display. In FIG. 3, the structure comprises a liquid crystal layer 112, and the arrows thereon indicate the rubbing direction of the glass substrate, that is, the orientation of the liquid crystal. At each side of the liquid crystal layer 112 is disposed a wide view film 110 and a polarizer 104. The arrows on the polarizer 104 indicate the polarization direction thereof. As shown in FIG. 3, the polarization directions of the top and bottom polarizers 104 are perpendicular to each other. The operation directions of the wide view films 110 are also illustrated by the arrows thereon, and are perpendicular to each other as well.

A light beam incident on the top polarizer 104 is polarized with an angle of 450. The light beam then travels through the liquid crystal layer 112 controlled by a voltage and further polarized into a polarization direction identical to that of the bottom polarizer 104. Therefore, the light beam can travel through the liquid crystal display as shown in FIG. 3. However, as most polarizers 104 have the problem of light leakage, the image quality is poor.

FIG. 5 shows the structure of a conventional wide viewing angle film fabricated by TAC less method. In FIG. 5, the structure comprises an adhesion layer 200. A wide viewing angle layer 202, a first TAC substrate 204, a second adhesion layer 206, a second TAC substrate 208, a PVC aligning film 210, a third TAC substrate 212 and a protection film 214 are sequentially formed on the adhesion layer 200. The structure of such conventional product does not include a phase retardation plate, while the PVA aligning film 210 has the polarization function.

### SUMMARY OF INVENTION

The present invention provides a structure of a liquid crystal display, which incorporates a phase retardation film in front of or behind a wide view film to retard the polarized light traveling through a polarizer, so as to prevent light leakage and increase contrast ratio.

The structure of liquid crystal display provided by the present invention comprises a first polarizer, a first phase retardation plate, a first wide view film, a liquid crystal plate, a second wide view film, a second phase retardation plate and a second polarizer. The first polarizer has a polarization direction along a first angle. The first phase retardation plate is disposed in front of the first polarizer to produce a phase retardation effect with a delay direction along the first angle. The first wide view film is disposed in front of the first phase retardation plate with a second angle perpendicular to the first angle. The liquid crystal plate is disposed in front of the first wide view film. The liquid crystals are aligned along the second crystal. The second wide view film is disposed in front of the liquid crystal plate and oriented with the first angle. The second phase retardation plate is disposed in front of the second wide view film and oriented with the second angle. The second polarizer is located in front of the second phase retardation plate and oriented with the second angle.

In the above structure, two phase retardation plates are used. In the general application, only one phase retardation plate can also be used. The direction of slow axis of the phase retardation plate is parallel to the polarization direction of the light beam.

The phase retardation plate can also be disposed between the wide view film and the liquid crystal plate instead of being between the polarizer and the wide view film as mentioned above.

The present invention further provides a wide viewing angle device including a first adhesion substrate. The first wide view film is disposed on the first adhesion substrate. A first TAC substrate is formed to cover the wide view film. A second adhesion substrate is disposed on the first TAC substrate. A phase retardation plate is formed on the second adhesion substrate. A PVA aligning film is formed on the phase retardation plate. A second TAC substrate is placed to cover the PVA aligning film. A protection film is then formed on the second TAC substrate.

In the above wide viewing angle device, a phase retardation plate is used to replace the conventional TAC substrate. The cost and the total thickness of the wide viewing angle device are thus reduced, and the chromatic aberration is alleviated.

### BRIEF DESCRIPTION OF DRAWINGS

These, as well as other features of the present invention, will become more apparent upon reference to the drawings wherein.

FIG. 1A shows a schematic top view of the relationship between a typical viewing angle and a liquid crystal display.

FIG. 1B shows a side view of FIG. 1A.

FIG. 2 shows a conventional liquid crystal display and the display theory thereof.

FIG. 3 shows the structure of a conventional liquid crystal display.

FIG. 4A shows the structure of an A-type liquid crystal display provided by the present invention.

FIG. 4B shows the structure of a B-type liquid crystal display provided by the present invention.

FIG. 5 shows the structure of a conventional wide view film.

FIG. 6 shows the structure of a wide view film provided by the present invention.

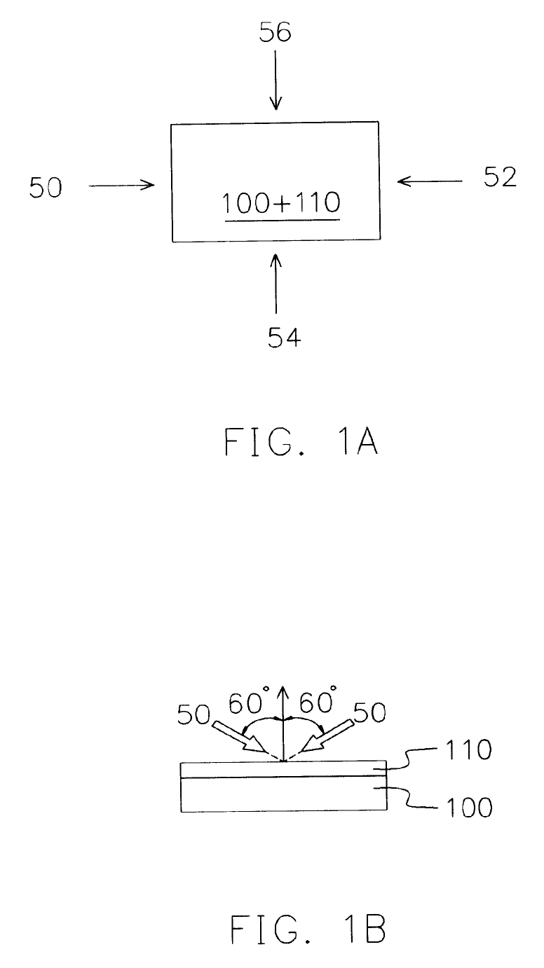

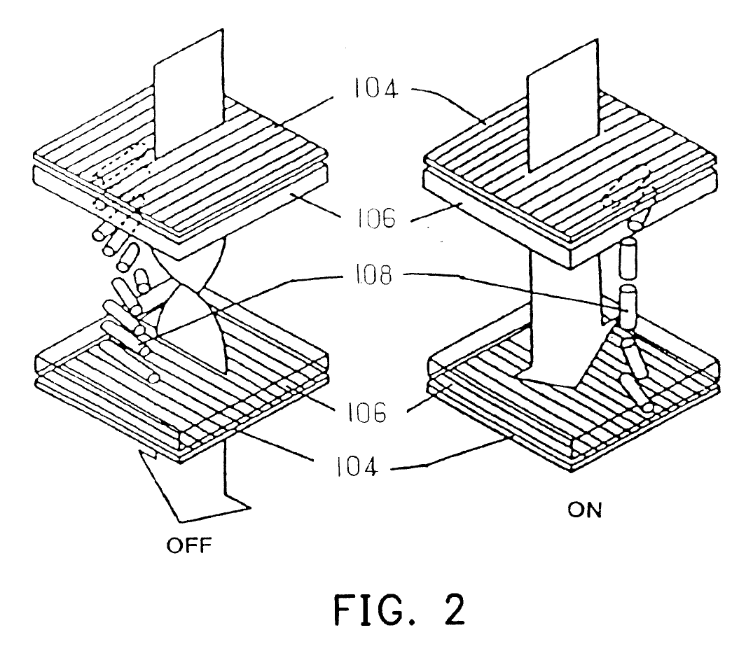

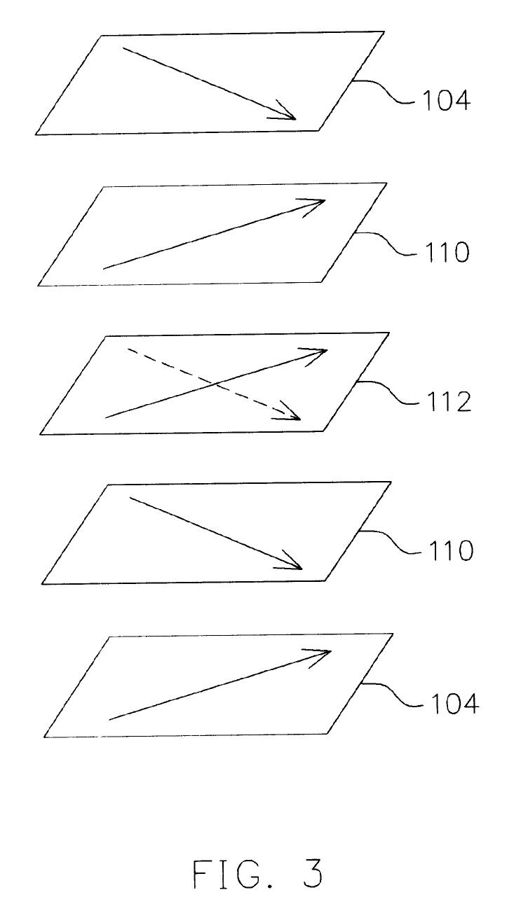

### DETAILED DESCRIPTION

The present invention provides a display structure using a phase retardation plate disposed in front of or behind the wide view film to compensate the light leakage caused by the polarizer. Thereby, a high contrast ratio is maintained even with a large viewing angle. The contrast ratio is maintained to as high as over 50. This is particular advantageous for the top viewing angle with an improvement of five to ten times.

The phase retardation plate can be used to replace the one of the several TAC substrates. Thereby, the cost is saved and the total thickness is reduced. Consequently, the chromatic aberration is alleviated.

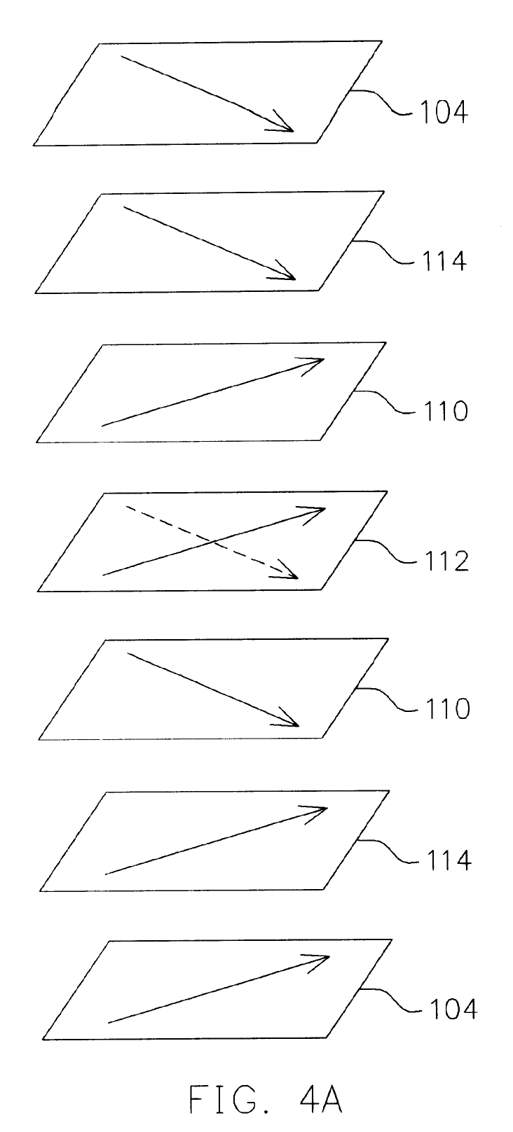

FIG. 4A shows the structure of an A-type liquid crystal display. In FIG. 4A, to resolve the light leakage problem caused by the polarizer, a phase retardation plate 114 is introduced between the polarizer 114 and the wide view film 110. This is called the A-type liquid crystal display. The physical structure of the phase retardation plate 1 14 includes a birefringence crystal with a crystal long axis and a crystal short axis. The crystal long axis having a larger refractive index and a slower propagation speed of light is referred to as the slow axis. In contrast, the crystal short axis having a smaller refractive index and a faster propagation speed of light is referred to as the fast axis. The slow axis of the phase retardation plate 1 14 is along the plane thereof.

The structure with the wide view film and the phase retardation plate is introduced as follows. A top polarizer 104 having a first polarization direction, for example, 450 polarization direction, is provided. A top phase retardation plate 114, the slow axis of the top phase retardation plate 114 with an orientation along the first direction is disposed under the top polarizer 104, which is the same as that of the light beam traveling through the top polarizer 104. A top wide view film 110 is disposed under the top phase retardation plate 104 with an operation direction, that is, the second direction as indicated by the arrow, perpendicular to the first direction. A liquid crystal layer 112 is disposed under the top wide view film 110 with the liquid crystals thereof aligned along the second direction as indicted as the arrow thereon. A bottom wide view film 110 is disposed under the liquid crystal layer 112 with an operation direction indicated by the arrow thereon. The operation direction of the bottom wide view film 110 is perpendicular to that of the top wide view film 110, that is, along the first direction. A bottom phase retardation plate 114 is disposed under the bottom wide view film 110 with a slow axis oriented along the second direction. A bottom polarizer 104 is further disposed under the bottom wide view film 110 with a polarization direction along the second direction.

In the above structure, a dual side design of the phase retardation plates 114 is adapted. That is, in relation to the liquid crystal layer 112, the phase retardation plates 114 are symmetrically disposed to obtain a good symmetry of left and right viewing angle. However, as the cost of the phase retardation plates 114 is high, and the volume is large, a single-side design of the phase retardation plate 114 can also be applied to the structure of liquid crystal display, that is, one phase retardation plate 114 is used. Though the symmetry between the left and right viewing angles is relatively inferior, the single side design effectively enhances the image quality for a large viewing angle.

The phase retardation plate includes a birefringence crystal, of which the refractive index of the long axis and the short axis is ne and no, respectively. The thickness of the phase retardation plate determines the phase retardation. The phase retardation is typically expressed by #nd, where #n =(ne-no), which is the differential diffractive index between the long axis and the short axis, and d is the thickness. For example, for the A-type design, the range of #nd is between about 20 nm to about 300 nm.

According to the relative position of the phase retardation plate and the liquid crystal layer, a B-type liquid crystal device is illustrated in FIG. 4B. The structure is similar to that as shown in FIG. 4A. However, the phase retardation plates are located between the wide view films 110 and the liquid crystal layer 112. Again, a dual-side or single-side design of the phase retardation plate 114 can be applied.

For the B-type design, #nd ranges between 20 to 100 or 400 to 600 nm.

According to the actual design and empirical results, the present invention provides significant enhancement by adapting the phase retardation plate. The contrast ratio is increased 5 to 10 times. For a phase retardation plate with ne=0.51 and no=0.5, such that #n=0.01, and an operation voltage according to the specific liquid crystal material, typically lower than 10V, the contrast ratio for A-type and B-type designs with a single-side phase retardation plate, the results are shown as table 1. In this example, the thickness of the phase retardation plate is determined according to the differential refractive index #n. Generally speaking, the thickness is smaller

TABLE 1

| | Viewing Angle (CR > 10) | | | |
|---|---|---|---|---|
| | Left | Right | Top | Bottom |
| Wide View Film | 60 | 60 | 40 | 60 |
| (Without Phase | | | | |
| Retardation Plate) | | | | |
| A-Type | >80 | >80 | 50 | 45 |
| | (60°, CR = 85) | (60°, CR = 85) | | |
| B-Type | >80 | >80 | 35 | 75 |
| | (60°, CR = 200) | (60°, CR = 200) | | |

From Table 1, the contrast ratio is greatly enhanced to obtain a clearer image by application of the phase retardation plate.

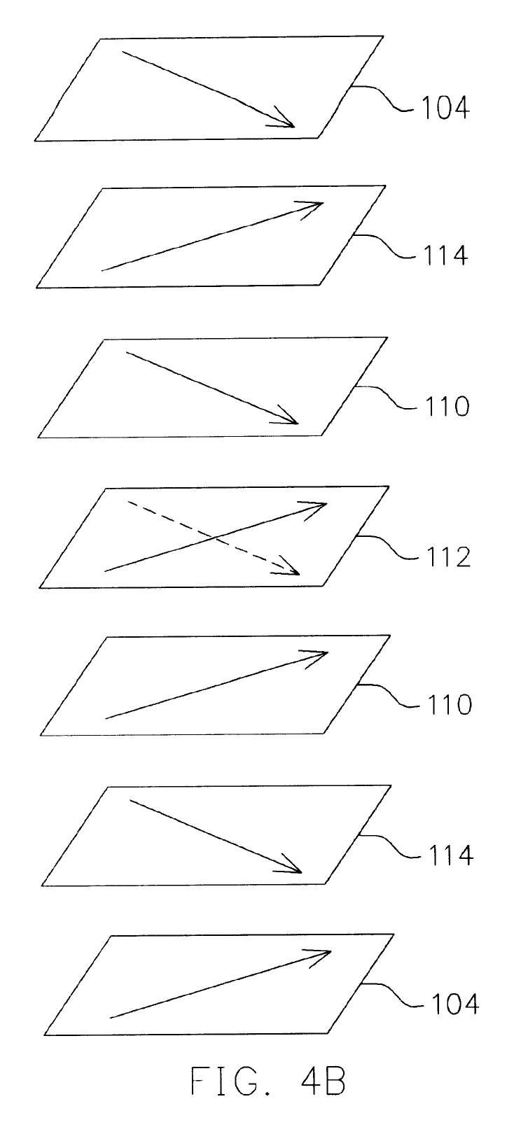

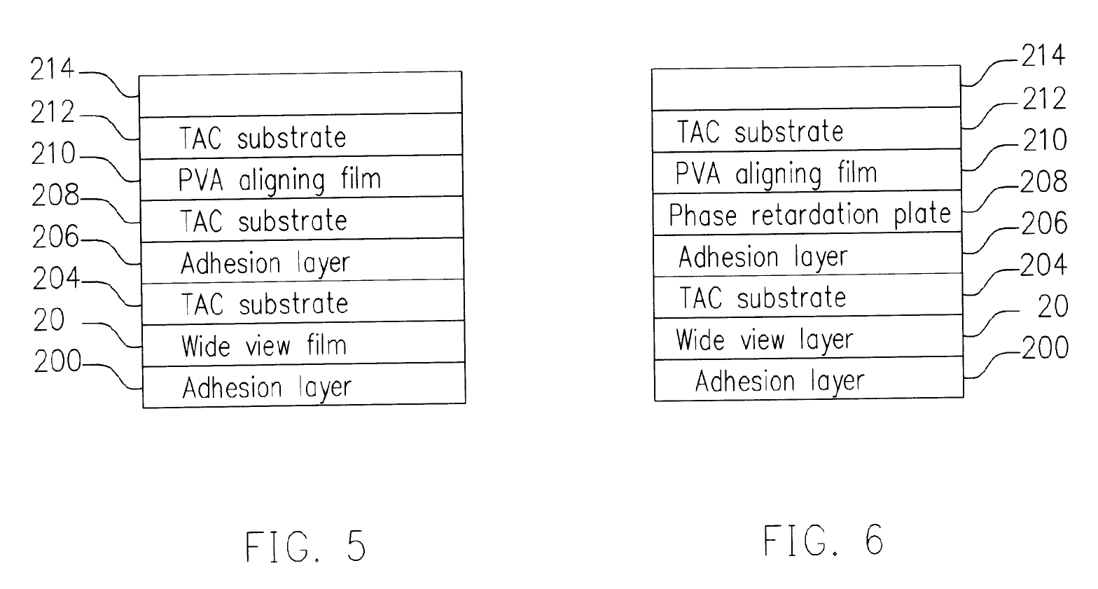

The phase retardation plate not only enhances the contrast ratio of the liquid crystal display, but also is applicable to fabrication of the wide view film to replace the TAC substrate. The phase retardation film in the conventional design is illustrated in FIG. 5. In this embodiment, a TAC substrate 208 is replaced with a phase retardation plate 216. In FIG. 6, the structure of a wide view film fabricated by a TAC less method is illustrated. In the present invention, the cost is saved, the total thickness of the wide view film is reduced, and the chromatic aberration is alleviated. In FIG. 6, the PVA aligning film is also a polarization device used as a polarizer. Therefore, the design principle of the structure as shown in FIG. 6 is similar to that of an A-type design.

The viewing angle of the liquid crystal panel is increased by increasing either the thickness of the wide view film or the TAC substrate of the polarizer such as the TAC substrate 204, 208 or 212. Currently, #nd of the TAC substrate 204 and TAC 208 and TAC on the wide view film is about 80 nm and 40 nm, respectively. Therefore, the total #nd of the TAC substrates 204 and 208 is about 120 nm. By increasing the thickness of the TAC substrates 204 and 208 to obtain a total #nd of about 200 nm to about 300 nm, the viewing angle of the liquid crystal display increases 100 to 200 without attaching an additional phase retardation plate. With the phase retardation plate, the wide view angle is further increased.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A structure of a liquid crystal display, comprising:
a first polarizer, having a first polarization direction along a first angle;
a first wide view film disposed under the first polarizer, the first wide view film being oriented with a second angle perpendicular to the first angle;
a liquid crystal layer disposed under the wide view film, the liquid crystal layer having a plurality of liquid crystal molecules aligned along the second angle;
a second wide view film disposed under the liquid crystal layer and oriented with the first angle;
a second polarizer disposed under the second wide view film with a polarization direction along the second angle; and
a first phase retardation plate disposed between the first polarizer and the first wide view film or between the second polarizer and the second wide view film, wherein the first phase retardation plate is operative to produce a phase retardation effect and has a slow axis oriented along the polarization direction of either the first polarizer or the second polarizer to which the first phase retardation plate corresponds.

2. The structure according to claim 1, wherein the first phase retardation has a product of differential refractive index #n and a thickness d ranged between about 20 nm to about 300 nm, where the differential refractive index #n is the difference between refractive indices of a fast axis and the slow axis of the first phase retardation plate.

3. The structure according to claim 1, further comprising a second phase retardation plate disposed between the second polarizer and the second wide view film when the first phase retardation plate is disposed between the first polarizer and the first wide view film.

4. The structure according to claim 3, wherein the product of differential refractive index and the thickness for the second phase retardation plate is between about 20 nm to about 300 nm.

5. A structure of liquid crystal display, comprising:
a first polarizer, having a first polarization direction along a first angle;
a first wide view film disposed under the first polarizer, the first wide view film being oriented with a second angle perpendicular to the first angle;
a liquid crystal layer disposed under the wide view film, the liquid crystal layer having a plurality of liquid crystal molecules aligned along the second angle;
a second wide view film disposed under the liquid crystal layer and oriented with the first angle;
a second polarizer disposed under the second wide view film with a polarization direction along the second angle; and
a first phase retardation plate disposed between the first wide view film and the liquid crystal layer or between the second wide view film and the liquid crystal layer, wherein the first phase retardation plate is operative to produce a phase retardation effect and has a slow axis oriented along the polarization direction of either the first polarizer or the second polarizer to which the first phase retardation plate corresponds.

6. The structure according to claim 5, wherein the first phase retardation plate has a product of differential refractive index #n and a thickness d ranged from about 20 nm to about 100 nm or from about 400 nm to about 600 nm, where the differential refractive index is the difference between refractive indices of a fast axis and the slow axis of the first phase retardation plate.

7. The structure according to claim 5, further comprising a second phase retardation plate disposed between the second wide view film and the liquid crystal layer when the first phase retardation plate is disposed between the first wide view film and the liquid crystal layer.

8. The structure according to claim 7, wherein the product of differential refractive index and the thickness for the second phase retardation plate is ranged about 20 nm and about 100 nm or about 400 nm and about 600 nm.

9. A structure of a liquid crystal display, comprising:
a polarizer, with a polarization direction along a first angle;
a wide view film disposed under the polarizer, wherein the wide view film is orientated to a direction with a second angle perpendicular to the first angle;
a liquid crystal layer disposed under the wide view film, the liquid crystal layer having a plurality of liquid crystal molecules orientated along the second direction; and
a phase retardation plate disposed between the polarizer and the wide view film or between the wide view film and the liquid crystal layer, wherein the phase retardation plate is operative to generate phase retardation effect with a slow axis thereof identical to polarization direction of the polarizer.

10. The structure according to claim 9, wherein the phase retardation has a product of differential refractive index #n and a thickness d ranged between about 20 nm to about 300 nm, where the differential refractive index #n is the difference between refractive indices of a fast axis and the slow axis of the phase retardation plate.

11. The structure according to claim 9, wherein the phase retardation plate has a product of differential refractive index #n and a thickness d ranged from about 20 nm to about 100 nm or from about 400 nm to about 600 nm, where the differential refractive index is the difference between refractive indices of a fast axis and the slow axis of the phase retardation plate.

12. A wide view film device, comprising:
a first adhesion substrate;
a wide view film on the first adhesion substrate;
a first TAC substrate covering the wide view film;
a second adhesion substrate on the first TAC substrate;
a phase retardation plate on the second adhesion substrate;
a PVA aligning film on the phase retardation plate; a second TAC substrate covering the PVA aligning film; and a protection film on the second TAC substrate.
